(19) United States
(12) Patent Application Publication
(10) Pub. No.: US 2007/0277687 A1
(43) Pub. Date: Dec. 6, 2007

(54) Printing Ink Units of a Printing Machine and Printing Mechanism with a Pump Inking Unit

(76) Inventor: Bernd Kurt Masuch, Kurnach (DE)

Correspondence Address: Douglas R. Hanscom;Jones Tullar & Cooper, P.O. BOX 2266 Eads Station, Arlington, VA, 22202, US

(21) Appl. No.: 11/663,161

(22) PCT Filed: Sep. 16, 2005
(86) PCT No.: PCT/EP05/54621

§ 371 Date: Mar. 19, 2007

(30) Foreign Application Priority Data
Sep. 17, 2004 (DE) 10 2004 045 673.9

(51) Int. Cl. B41F 31/08

(52) U.S. Cl. 101/216; 101/363

(57) ABSTRACT

A pump inking unit of a printing machine is usable to dose a predetermined amount of ink onto axially adjacent areas of a peripheral surface of a roller, by the provision of a discharge opening, with the aid of several dosing pumps. These several dosing pumps are arranged adjacent each other in an axial direction of the roller. Each one of these dosing pumps has its own motor. The adjacently arranged dosing pumps are arranged along an application strip that is provided with the discharge openings. Each of these dosing pumps is a rotating displacement pump with an externally toothed, internal rotor and with an internally toothed external motor. The axes of rotation of these two rotors are eccentric to each other. The teeth of the external and internal rotors are at any time in engagement with each other to form a system of several sealed transport chambers between the external rotor and the internal rotor, during rotation of these rotors about their individual axes of rotation.

The invention relates to pump inking units of a printing press, as well as to a printing group having a pump inking unit in accordance with the preamble of claim 1 or 2 or 27.

In contrast to customary film inking units, in pump inking units the amount of ink to be introduced into the inking unit is not provided by means of inking blades, but by means of exact metering via valves and/or pumps. This takes place in an exactly tailored manner for each individual ink color zone, for example. For reasons of expense and/or structural space, in some cases the supply of a defined pressure level is provided for several color zones arranged side-by-side in the axial direction, wherein metering can be individually regulated per color zone or group of color zones, for example, by valves.

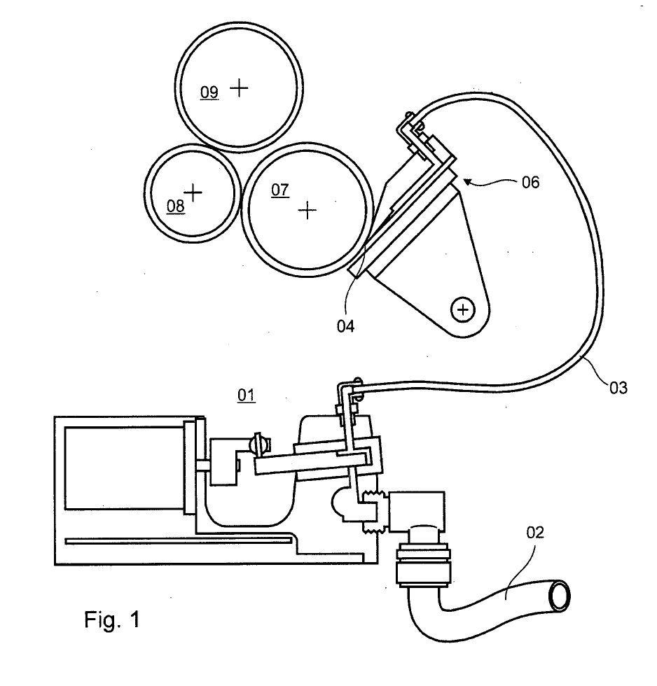

FIG. 1 schematically shows a pump inking unit, wherein a pump 01, in this case an oblique-shaft (double) piston pump 01, is provided here per color zone or group of color zones to be supplied. These pumps 01 are supplied via a feed line 02 from a not represented ink reservoir and give out the pumped ink via lines 03 (hoses) to an appropriate opening 04, for example a metering opening 04, of an applicator strip 06. Several such openings 04, feeds and hoses are provided in the axial direction. For reasons of structural space, the pumps are here arranged away from the applicator strip, which is disadvantageous in view of long supply paths, material and lack of compactness. The ink is applied, metered through the opening 04 by means of the pump 01, to a roller 07 of an inking unit, for example a doctor roller 07. From there, the ink is passed on to a film roller 08 and an ink transfer and/or ink applicator roller 09, for example.

A pump inking unit of a printing press is known from DE 698 09 580 T2, wherein a defined amount of ink can be metered through respective supply openings by means of several metering pumps onto axially adjacent areas of a roller shell surface, and wherein several of the metering pumps are arranged side-by-side in the axial direction of the inking roller in an applicator strip. The metering pumps are embodied as gear pumps or other suitable positive-displacement pumps.

In a pump inking unit, DE 26 26 006 A1 discloses displacement pumps embodied as sickle-tooth gear pumps, having an externally-toothed interior rotor and an internally-toothed exterior rotor, whose axes of rotation are seated eccentrically in respect to each other. A sickle-shaped insert element is provided in the blending space for forming a suction and a pressure chamber.

A pump inking unit is disclosed in DE 20 43 078 which, in one embodiment, has several pumps side-by-side, in particular gear pumps, between a common feed line and each of the respective bores of a distributor block.

A metering pump embodied in the form of a rotatory displacement pump with an externally-toothed interior rotor and an internally-toothed exterior rotor is shown in EP 0 852 674 B1 and in the material of a prospectus of the HNP Mikrosysteme GmbH company of Parchim, whose axes of rotation are seated eccentrically in respect to each other, wherein the exterior and the interior rotors have a cycloid-shaped tooth arrangement, whose cycloid-shaped tooth arrangement is in meshing engagement and forms a system of several sealed conveying chambers in the course of rotation.

The object of the invention is based on creating pump inking units of a printing press, as well as a printing unit with a pump inking unit.

In accordance with the invention, the object is attained by means of the characteristics of claim 1 or 2, or 27.

The advantages to be obtained by means of the invention lie in particular in that a compact pump inking unit is created, which is highly precise in respect to metering.

The advantages over a conventional film inking unit, which can be attained by a pump inking unit, appear in the form of a simpler basic setting, start-up and/or ink curve determination. The influence of changes in the basic setting, such as film roller spacing, bending of the doctor device (or the doctor roller), etc., is reduced. Improvements can be achieved in the resolution of the actuating steps, in particular in the range of narrower surface-covering degrees.

In contrast to single- or double-piston pumps, clearly evened-out conveyance can be achieved (low pulsation, small lost volume) by the employment of gear pumps or annular gear pumps, in a special embodiment by rotatory displacement pumps with an externally-toothed interior rotor and an internally-toothed exterior rotor. Such a pump (also called a metering pump in what follows) is known, for example, from HNP Mikrosysteme GmbH. It can be produced with an extremely small structural space and has a high precision in metering accuracy.

Because of the small structural space it is now possible to provide an individual pump per ink zone—in particular side-by-side in the axial direction—directly at the applicator strip. Preferably each one of the pumps has its own motor and, in an advantageous variation, its own control unit for the driving thereof.

In another embodiment, the pump is designed as a gear pump, for example internally-toothed gear pump or externally-toothed gear pump. In this case each pump can preferably have its own motor, and in an advantageous embodiment its own control unit, for example a control board.

Exemplary embodiments of the invention are represented in the drawings and will be described in greater detail in what follows.

Shown are in:

FIG. 1, a pump inking unit in accordance with the prior art,

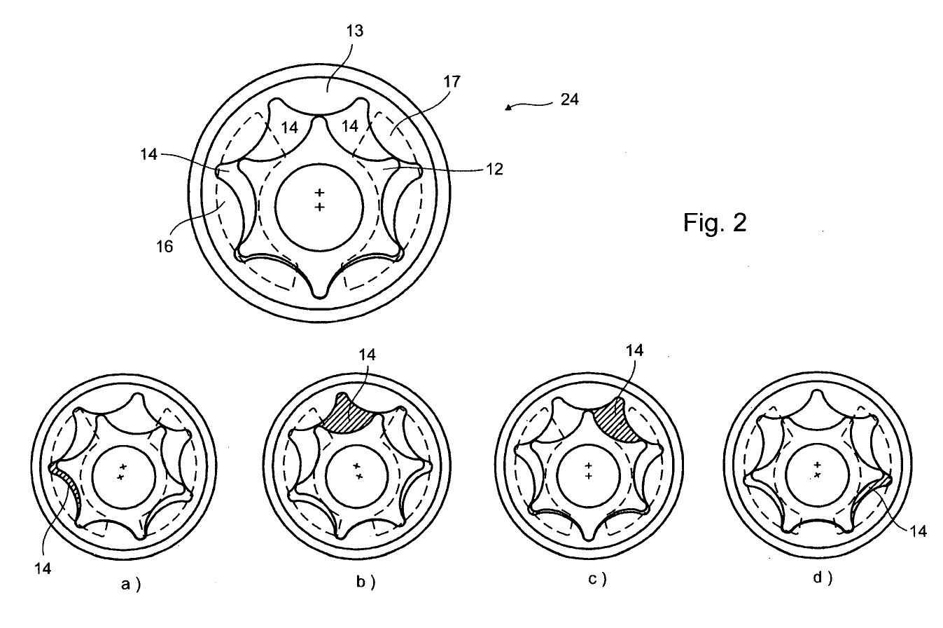

FIG. 2, the functional principle of a metering pump in a first embodiment,

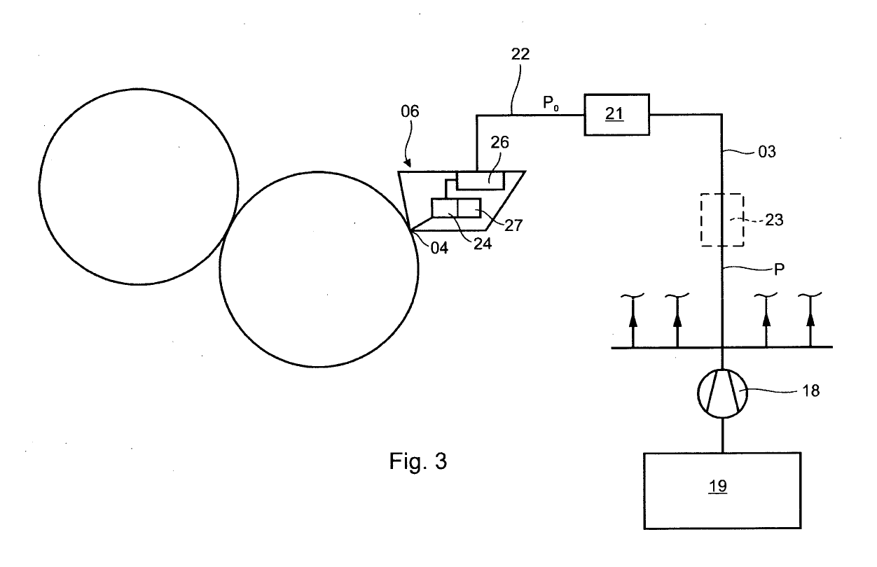

FIG. 3, a conception of the pump inking unit of the invention with a metering pump,

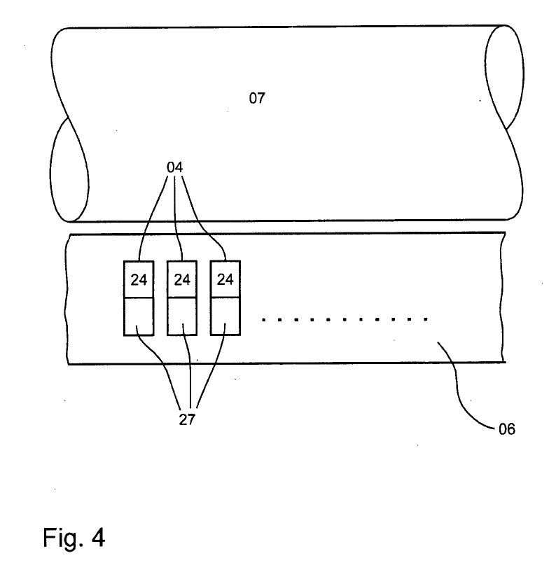

FIG. 4, a schematic sectional view with applicator strip, metering pump and motor,

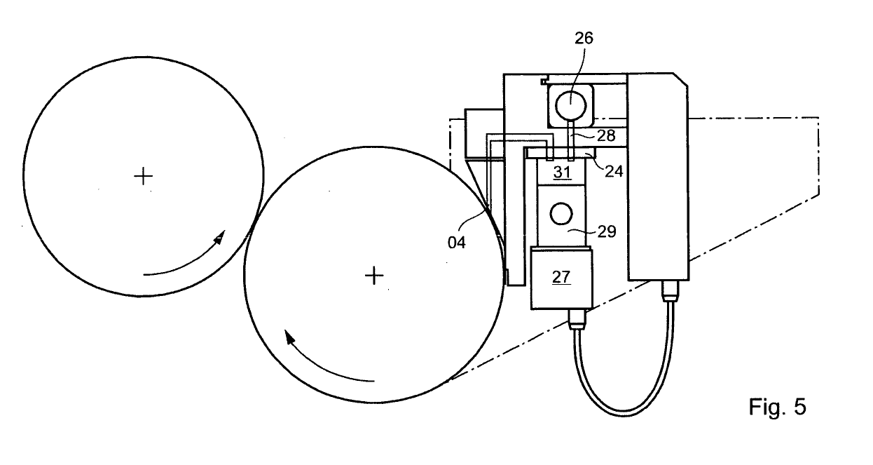

FIG. 5, a first embodiment variation of the pump inking unit,

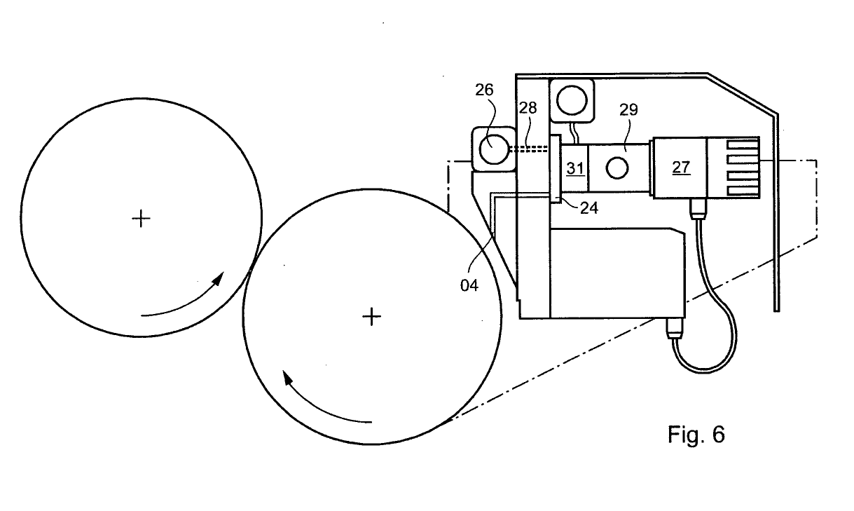

FIG. 6, a second embodiment variation of the pump inking unit,

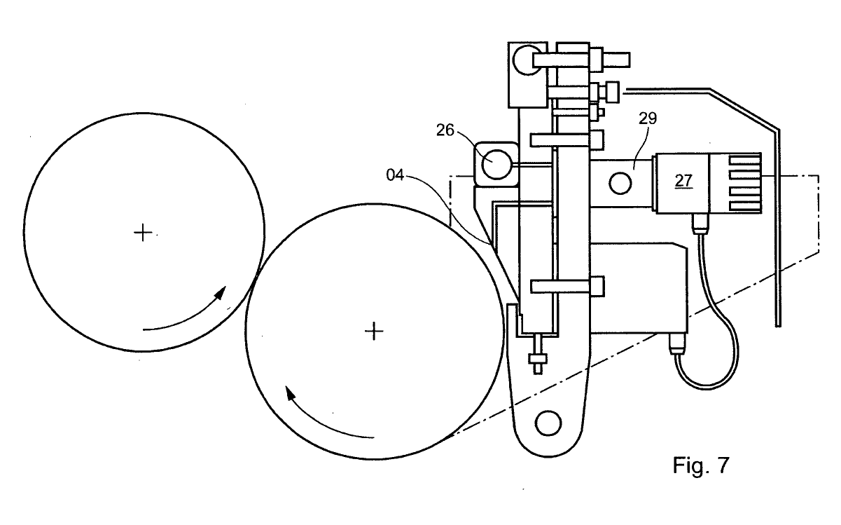

FIG. 7, a pivotable embodiment in accordance with FIG. 5, brought into contact,

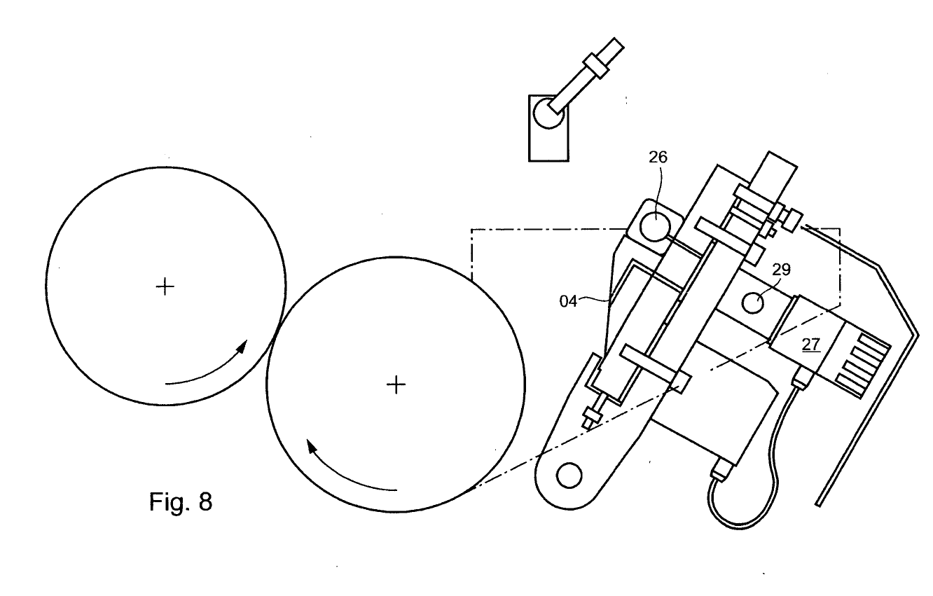

FIG. 8, a pivotable embodiment in accordance with FIG. 5, brought out of contact,

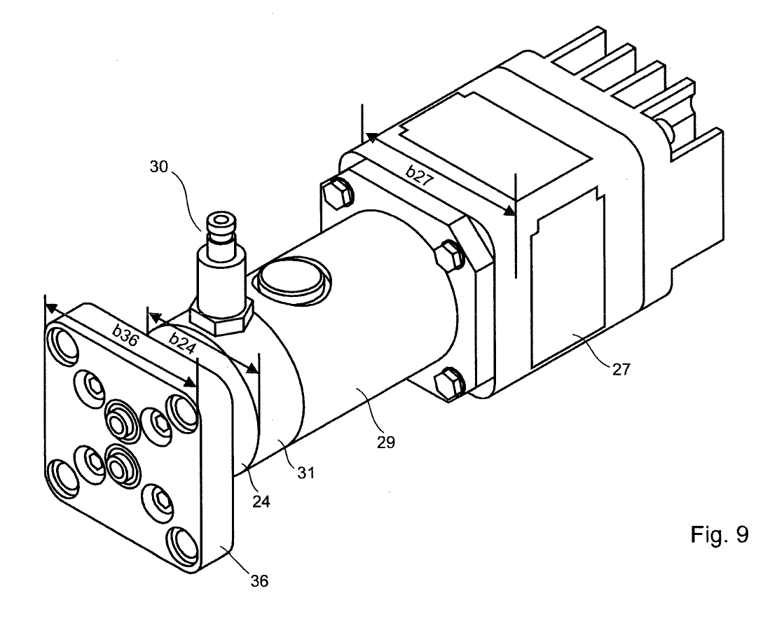

FIG. 9, a spatial representation of the structural component “pump”,

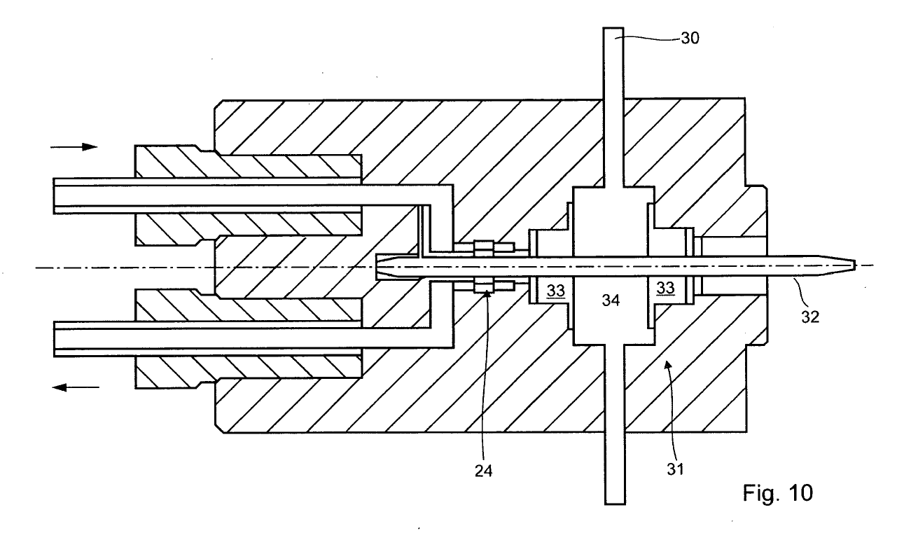

FIG. 10, a schematic representation of the component consisting of pump unit, seal and driveshaft,

FIG. 11, a schematic representation of a second embodiment of the metering pump in a sectional view,

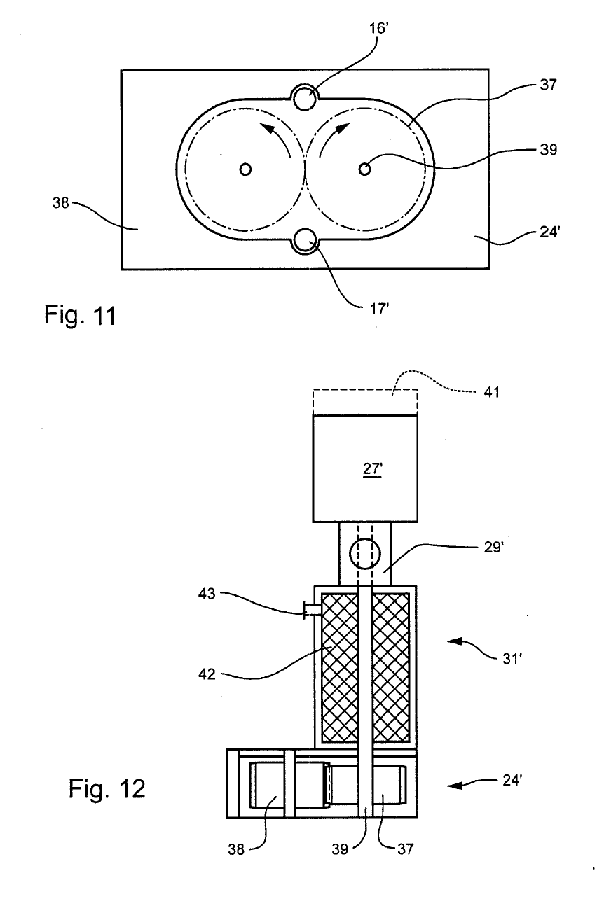

FIG. 12, a schematic representation of the pump unit with the embodiment of the metering pump in accordance with FIG. 11, a barrier seal, a coupling and a motor,

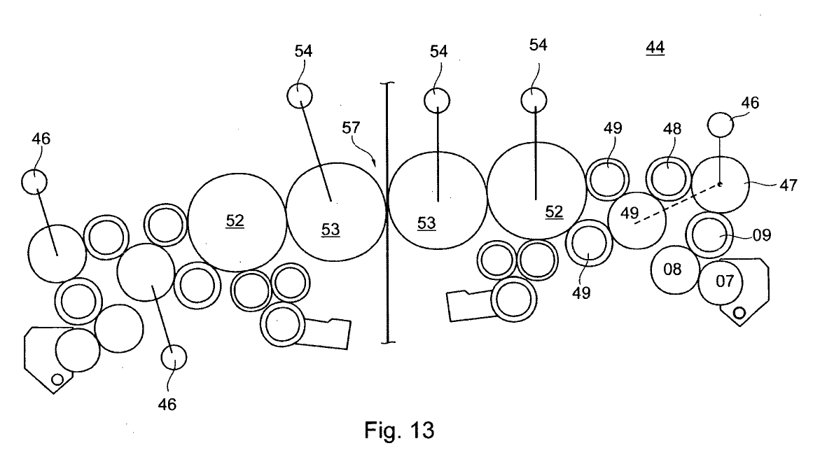

FIG. 13, a schematic representation of the pump inking unit in an inking system of a printing group,

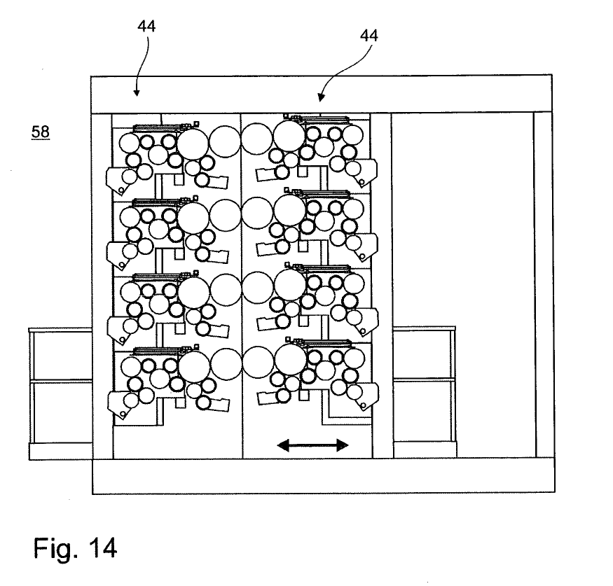

FIG. 14, a schematic representation of the printing group with the pump inking unit in a printing unit.

As already described above, FIG. 1 shows a known pump inking unit with several openings, arranged axially side-by-side, for the exit of ink, wherein the individual openings 04 are supplied by means of pumps 01, here oblique-shaft piston pumps 01, which are spatially separated from the applicator strip 06.

In an exemplary embodiment of the pump inking unit in accordance with the invention represented in FIGS. 2 to 10, the conveyance or metering of the ink in the pump inking unit takes place by means of pumps 11, which are based on the micro-tooth ring principle, such as is known, for example, by relevant prospectus material of the HNP Mikrosysteme GmbH company; in particular by means of rotatory displacement pumps with an externally-toothed interior rotor 12 and internally-toothed exterior rotor 13, which are seated slightly eccentrically in respect to each other. Conveying chambers 14, formed on the aspirating side 14 between the exterior and the interior rotors 12, 13, increase in size in the course of the rotation of the rotors around their offset axes, while they are simultaneously decreased in size on the pressure side 17. In FIG. 2, the aspiration and pressure sides 16, 17 are represented in a kidney shape by means of the corresponding inlet opening 16 and outlet opening 17. In this way an even and almost pulsation-free conveyed flow is created between the inlet and outlet openings 16, 17. With their cycloid teeth, the exterior and interior rotors 12, 14 are in meshing engagement, and in the course of rotation they form a system of several sealed conveying chambers 14 at any time. The number of teeth of the internal and external tooth arrangement is different. In the course of the rotation of the rotors around their offset axes, the conveying chambers on the aspirating side increase in size, while at the same time they decrease in size on the pressure side, such as is schematically indicated by a conveying chamber 14, filled by dashed lines, in FIGS. 2 a) to d).

Advantageously, the tip diameter of the interior rotor 12 substantially corresponds to the root diameter of the exterior rotor 13, decreased by the tooth depth, or the reference diameter of the interior rotor 12 substantially corresponds to the reference diameter of the exterior rotor 13, reduced by half the tooth depth. The presence of several closed conveying chambers 14 is made possible in this way, for example.

FIG. 3 represents the conception of the pump inking unit of the invention, wherein ink is conveyed from an ink reservoir 19, for example a feed container 19 of a central ink supply device, by means of a pump 18, or a condenser 18, to the applicator strip 06. The pump, or the condenser 18, has its own drive motor (not represented), which is independent of other units. Several metering pumps 24 (in particular a number corresponding to the number of the axially side-by-side arranged zones) are provided on or in the applicator strip 06. Preferably only one feed line 03 (per printing group) needs to lead to the applicator strip 06. A pressure regulator 21, for example a pressure reducer 21, is arranged in the feed line 03, by means of which, independent of the admission pressure, a pressure P₀ located downstream thereof in the feed line 22 to the metering pumps 24 can be set. Preferably the pressure P₀ in the feed line is set to at least 1 bar (above the surroundings), advantageously to at least 2 bar, in particular to 3 to 5 bar. In addition, in an advantageous embodiment a filter 23 can be arranged on the path of the ink from the reservoir to the metering pump. The presence of an admission pressure, in particular a defined admission pressure, is of particular advantage, because in this case the metering pump 24 need not primarily for the. It is possible by means of this to achieve more exact metering and a reduced structural size of the motor. However, if work is performed with a significant admission pressure, a barrier seal (see below) should be provided in an advantageous embodiment in order to prevent the exit of ink in the direction of the driveshaft and a pressure drop in the metering pump 24.

As represented in a schematic sectional view in FIG. 4, the several metering pumps 24 are provided on or in the applicator strip 06, which are together fed via the feed line 22, not represented here. As represented in FIG. 3, in an advantageous embodiment for the supply of the metering pumps 24, the applicator strip 06 can have an axially extending “on-site reservoir” 26, for example in the form of a pipe (ink supply strip 26), transversely extending over one, two or more printed pages, with the corresponding number of lines 28 leading to the respective metering pumps 24 (FIGS. 5, 6). In an advantageous embodiment, each metering pump has its own drive mechanism 27, for example a motor 27, which is mechanically independent of the other metering pumps 24.

Two embodiment variations of the spatial arrangement of the metering pump 24 (with a motor 27 and a coupling connecting the motor 27 with the metering pump) are represented in FIGS. 5 and 6. A hydraulic fluid supply for a barrier seal 31 is additionally represented in FIG. 6.

Lines or conduits leading from the ink supply strip 26 to an inlet of the metering pump 24, and from an outlet of the latter to the delivery opening 04, are also indicated. Because of the highly viscous ink, a cross section in the area of the inlet and/or outlet to or from the metering pump 24 (and preferably the conduits) should for example be at least 10 mm², in particular at least 15 mm². In particular, with a maximally operationally required volume flow Vₘₐₓ (for example 10,000 or 15,000 mm³), a minimal cross sectional surface Q should be selected in such a way that Q≧1/(1,000 mm)*Vₘₐₓ applies. Preferably this should apply to the entire supply path between the ink supply strip 26 to the (kidney-shaped) inlet opening 16 and/or from the (kidney-shaped) outlet opening 17 to the delivery opening 04.

FIGS. 7 and 8 represent the pump inking unit in the embodiment in accordance with FIG. 6, wherein the device is seated movably, in particular pivotably, on a frame in the printing group or the inking unit.

FIG. 9 shows a pump unit as a component with the pump 24 (here the pump mechanism with the above mentioned micro-tooth ring pump, for example), an area containing the barrier seal 31, a coupling 29 which, if applicable, compensates angular deviations and/or offset, and an area containing the motor 27. The motor 27 is preferably designed as a step motor 27, for example with a resolution of at least 100, in particular between 200 and 400, steps per revolutions. In this way an extremely low conveying rate can be achieved with sufficient accuracy.

The pump 24 (here the pump mechanism with externally-toothed interior rotor and internally-toothed exterior rotor), the driveshaft 32 and the barrier seal 31 are represented enlarged and in section in FIG. 10. To prevent pigment-containing ink escaping from the pump chamber along the driveshaft, a barrier seal 31 with two seals 33 (for example Teflon) enclosing the driveshaft and a pressure chamber 34 located between them, is provided, in which oil under pressure is contained. If the seal 33 should not seal completely, at most a small amount of oil flows in the direction of the pump chamber.

Advantageous characteristics for laying out and/or operating the metering pump, or a characterization of an advantageous dimensioning of the metering pump are shown in the following table.

| | |
|---|---|
| Medium: | Ink for coldset (or headset) printing |
| Density: | 0.98 . . . 1.1 kg/dm³ |
| Up to max. volume flow of: | 1.5 l/h (25 ml/min) |
| Average volume flow: | 0.2 . . . 0.4 l/h (3.3 . . . 6.6 ml/min) |
| From min. volume flow of: | 0.001 l/h |
| Dynamic viscosity⁽¹⁾ | 4 . . . 25 Pas ( . . . 45 Pas) |
| Medium flow: | continuously, if possible, short |
| | interruptions permissible |
| Pressure in the feed line: | 3 . . . 5 bar |
| Width of the pump⁽⁴⁾: | less than 50 mm, aprx. 35 . . . 43 mm |

( . . . .): Values in parentheses apply to headset printing
⁽¹⁾measured with a rotatory viscosimeter, plate-cone system, opening angle 0.3°, temp. 20° C.
⁽⁴⁾to be able to place the individual metering pumps side-by-side on the ink applicator strip, the width of the pump plus the drive mechanism should not exceed the stated value

In this case a maximum width b24, b27, b36 of the pump 24 and/or of the motor 27 and/or, if applicable, of a flange 36 holding the pump 24, which is less than 50 mm, in particular maximally 35 to 43 mm, in the axial direction of the inking unit, is of particular importance (see FIG. 9). A sort of “array” of side-by-side arranged metering pumps per zone (corresponding to the individual inking blades in customary film inking unit) is possible in this way. A regulating range of 0.001 l/h to 1.000 l/h, or even 1.500 l/h, assures a particularly dependable supply for the smallest (for example 1%) to the largest surface coverings (for example 100%) in the print image—and this within the range of production speeds of 4,000 rev/h to, for example 40,000 rev/h, of the cylinders carrying the printing formes. The demand is made on the metering pump that it provide accurate regulation to 1%, for example, over the entire above mentioned regulating range. This is made possible by means of one or several of the above mentioned measures (the above mentioned cross section, and/or employment of an above mentioned step motor, and/or short paths because of the possible arrangement of the pump on the applicator strip, and/or design of the pump unit as the above mentioned micro-tooth ring pump).

FIGS. 11 and 12 show only schematically a second embodiment of the metering pump 24 represented in schematic FIGS. 3 and 4, which is identified by 24′ in what follows. Therefore the reference numerals corresponding to the first embodiments are provided with an apostrophe. What has been explained in the respective sections can be applied in respect to the arrangement in the inking unit, or in or on the applicator strip 06, and/or the pivotability, and/or characteristics/layouts/dimensions mentioned in the table, and/or the drive mechanism, and/or the supply.

Here, the metering pump 24′ is embodied as an externally-toothed gear pump 24′ and has two gear wheels 37, 38, which mesh with each other, wherein only their pitch circles are represented. One of the gear wheels 37, 38 is driven via a shaft 39. In the course of driving the gear wheels in the direction indicated by the arrows, ink is transported from the area of the inlet opening 16′ between the teeth into the lower area of the outlet opening 17′. A return transport is prevented by the engagement of the teeth in the contact point, and the ink is transported out of the outlet 17′. The second gear wheel 38 can be merely rotatably seated.

The same as for the first embodiment of the metering pump 24, it can be advantageous to again provide a barrier seal 31′ and/or a coupling 29. The barrier seal 31′ can be embodied in the manner of the above mentioned barrier seal 31 with a pressure chamber 34 containing hydraulic fluid. However, in another advantageous embodiment it contains an elastic material which is under pressure and is arranged in the space between the shaft 39 and a housing of the barrier seal. The pressure on the elastic material 42, for example an elastomer, can be applied for example by means of a fluid, a gel, or also by grease. When employing a gel or grease, this can be introduced through a valve 43 or a connecting piece 43, which is to be closed afterward. In this case a supply system, such as required in connection with the embodiment of the hydraulic fluid-operated barrier seal 31, would not be necessary.

In a non-represented variation, the metering pump 24 can also be embodied as an internally-toothed pump.

For all embodiments in accordance with the invention, its own control unit 41, for example a control card 41, can be assigned to each metering pump 24, 24′, besides its own motor 27. It can preferably also be arranged, for example at the assigned motor 27, 27′, in numbers corresponding to the motors 27, 27′ on the applicator strip 06. However, a reduced number of control cards 27 can be provided in the area of the applicator strip 06, which then is respectively assigned to two, three or more motors 27, 27′. In principle it is also possible to arrange the control cards 41, or a common control card 41, structurally separated from the applicator strip 41.

Since with the described arrangement the amount of ink can be introduced into the inking unit in zones or as a whole via the control of the metering pumps 24, 24′, it is no longer required to operate the doctor roller 07 at a speed in regard to the required amount of ink which is a relative speed in comparison to the film roller 08. Therefore, in a first variation the doctor roller 07 does not require its own drive motor, which is mechanically independent of the film roller 08, but instead it can be driven via a mechanical driving connection by another roller of the inking unit. In a second variation, the doctor roller 07 can have its own drive motor which, however, is operated at fixed relative rpm in regard to the inking unit during the operation of the printing press. It is operated in such a way that the doctor roller operates at rpm which are proportionate to the production speed.

The pump inking unit is represented in the roller train of a printing group 44 in FIG. 13, wherein the ink is transported by the ink transfer roller 09 onto a distribution cylinder 47 remote from the printing location, a further ink transfer roller 48, a distribution cylinder 49 closer to the printing location, via application rollers 51 onto a forme cylinder 52 and from there to a transfer cylinder 53. At least one of the distribution cylinders 47, 49 is rotatorily driven by a drive motor 54, which is mechanically independent of the forme and transfer cylinders 52, 53. Here, in a first embodiment, the distribution cylinder 49 close to the printing location can be embodied without a forced rotatory drive mechanism, i.e. except for the friction gear constituted by the inking unit, without a separate mechanical drive connection with a motor, and the distribution cylinder 47 remote from the printing location can have the drive motor 54. In an embodiment shown by dashed lines (right side), a mechanical drive connection can exist between the two distribution cylinders 47, 49, wherein these are then driven together by a drive motor 46. In an embodiment, represented by way of example on the left, each distribution cylinder 47, 49 has its own drive motor 46 for being rotatorily driven. The distribution cylinders are traversingly seated and are either traversingly driven via a gear which converts the respective rotary motion into an axial movement, or by a separate traversing gear, for example motors.

In the ideal case, the forme and transfer cylinders 52, 53 are therefore individually driven by at least one drive motor 54 (individually, as shown on the right by way of example, or coupled in pairs by a common one, as shown on the left by way of example), at least one distribution cylinder 47, 49 by a drive motor 46, as well as the metering pumps 24, 24′ by at least one drive motor 27, 27′. Advantageously the feed pressure can also be adjusted by a motor which is mechanically independent of the mentioned motors.

Two printing groups 44 in the form of a double printing group in FIG. 13 form a printing location 57 on both sides of a web 56, in this case a so-called double printing location for imprinting both sides. In principle, the transfer cylinder could also constitute the printing location together with a counter-pressure cylinder, for example a satellite cylinder, and could be a part of a satellite printing unit.

FIG. 14 shows an exemplary embodiment, wherein a printing unit 58 is constituted as a printing tower 58, for example a so-called tower of eight, having several, for example four, double printing groups arranged on top of each other. For reasons of accessibility, the printing tower is designed so it can be separated in the area of its printing locations 57. This means that the lateral elements arranged on both front faces of the cylinders and rollers are designed divisible, for example in such a way that a space can be selectively formed between the cooperating transfer cylinders. For this purpose the right lateral frame half, for example, is seated to be horizontally movable (indicated by means of a two-headed arrow) in FIG. 14.

### LIST OF REFERENCE NUMERALS

01 Pump, oblique-shaft (double) piston pump

02 Feed line

03 Feed line

04 Delivery opening

05 -

06 Applicator strip

07 Roller, doctor roller

08 Film roller

09 Ink application roller

10 -

11 Pump

12 Interior rotor

13 Exterior rotor

14 Conveying chamber

15 -

16 Aspirating side, inlet opening

17 Pressure side, outlet opening

18 Pump, condenser

19 Ink reservoir, feed container

20 -

21 Pressure regulator, pressure reducer

22 Feed line

23 Filter

24 Metering pump, pump (pump mechanism)

25 -

26 On-site reservoir, ink supply strip

27 Drive mechanism, motor

28 Line

29 Coupling

30 -

31 Barrier seal

32 Driveshaft

33 Seal

34 Pressure chamber

35 -

36 Flange

37 Gear wheel

38 Gear wheel

39 Shaft

40 -

41 Control unit, control card

42 Elastic material

43 Valve, connecting piece

44 Printing group

45 -

46 Drive motor

47 Distribution cylinder

48 Ink transfer roller

49 Distribution cylinder

50 -

51 Application roller

52 Forme cylinder

53 Transfer cylinder

54 Drive motor

55 -

56 Web

57 Printing location

58 Printing unit, printing tower

b24 Width

b27 Width

b36 Width

P Pressure

P₀ Pressure (feed line)

1-29. (canceled)

30. A pump inking unit of a printing press and adapted to meter a defined amount of ink comprising:
an ink applicator strip usable to supply ink to an ink roller in said printing press, said ink applicator strip extending in an axial direction adjacent said ink roller;
a plurality of ink delivery openings spaced axially along said ink applicator strip;
a plurality of ink metering pumps arranged side-by-side in said axial direction of said ink roller with each of said plurality of ink metering pumps being in fluid connection with an associated one of said plurality of ink delivery openings; and
a separate drive means for each one of said plurality of ink metering pumps.

31. The pump inking unit of claim 30 wherein said separate drive means for each said ink metering pump is a drive motor.

32. The pump inking unit of claim 30 wherein said separate drive means for each said ink metering pump is a drive shaft.

33. The pump inking unit of claim 30 wherein each said ink metering pump is a rotary displacement pump and includes an externally-toothed interior rotor and an internally-toothed exterior rotor, said interior rotor and said exterior rotor having eccentrically located axes of rotation with respect to each other, said exterior teeth of said interior rotor and said interior teeth of said exterior rotor defining a system of several sealed ink conveying chambers between said interior rotor and said exterior rotor.

34. The pump inking unit of claim 30 further including an ink feed line to each of said plurality of ink metering pumps and wherein an ink pressure in each said ink feed line is at least one bar above ambient.

35. The pump inking unit of claim 34 wherein each said ink metering pump is a rotary displacement pump and includes an externally-toothed interior rotor and an internally-toothed exterior rotor, said interior rotor and said exterior rotor having eccentrically located axes of rotation with respect to each other, said exterior teeth of said interior rotor and said interior teeth of said exterior rotor defining a system of several sealed ink conveying chambers between said interior rotor and said exterior rotor.

36. The pump inking unit of claim 33 wherein said interior rotor and said exterior rotor have cycloid-shaped teeth.

37. The pump inking unit of claim 32 further including a separate motor driving each said drive shaft.

38. The pump inking unit of claim 30 wherein each said ink metering pump has an inlet opening and an outlet opening with a minimal cross-sectional surface Q and has a maximally operationally required volume flow V_{MAX} and wherein Q≧1/(1,000) mm*V_{MAX}.

39. The pump inking unit of claim 33 wherein one of said rotors is a step motor having a resolution of at least 100 steps per revolution.

40. The pump inking unit of claim 30 wherein a width of each said ink metering pump in an axial direction of said ink roller is less than 50 mm.

41. The pump inking unit of claim 31 wherein a width of each said ink metering pump drive motor, in an axial direction of said ink roller is less than 50 mm.

42. The pump inking unit of claim 32 further including a barrier seal adapted to seal said driveshaft of each said ink metering pump.

43. The pump inking unit of claim 42 wherein said barrier seal includes first and second driveshaft enclosing seals spaced along said driveshaft and defining a pressure chamber, said pressure chamber being filled with oil under pressure.

44. The pump inking unit of claim 42 wherein said barrier seal includes an elastic material under pressure.

45. The pump inking unit of claim 42 wherein a pressure in said barrier seal is greater than an ink pressure in each said ink metering pump during operation of each said ink metering pump.

46. The pump inking unit of claim 30 further including an external ink reservoir usable to supply ink to said plurality of ink metering pumps through an ink feed line and an ink feed pump intermediate said external ink reservoir and said plurality of ink metering pumps.

47. The pump inking unit of claim 46 further including an ink pressure regulator in said ink feed line intermediate said ink feed pump and each said ink metering pump.

48. The pump inking unit of claim 34 wherein said ink pressure in said ink feed line is at least 2 bar above ambient.

49. The pump inking unit of claim 48 wherein said ink pressure in said ink feed line is between 3 and 5 bar above ambient.

50. The pump inking unit of claim 46 further including a filter in said ink feed line.

51. The pump inking system of claim 46 wherein said ink reservoir is a feed container of a central ink supply usable with a plurality of printing groups.

52. The pump inking unit of claim 31 wherein each said ink metering pump drive motor is a step motor.

53. The pump inking unit of claim 52 wherein said step motor has a resolution of at least 100 steps per revolution.

54. The pump inking unit of claim 30 wherein each said ink metering pump is a rotary displacement pump having first and second gear wheels working together as an externally-toothed gear pump.

55. A printing unit comprising:
a forme cylinder;
at least one ink distributor cylinder adapted to supply ink to said forme cylinder;
at least one roller adapted to supply ink to said at least one distribution cylinder;
a pump inking unit having a plurality of ink metering pumps arranged in an axial direction of said at least one roller and adapted to supply ink to said at least one roller; and
independent drive motors for said forme cylinder, said at least one ink distribution cylinder and each of said plurality of ink metering pumps.

56. The printing group of claim 55 further including an ink feed pump before, in a direction of ink flow, said plurality of ink metering pumps and having an ink feed pump drive motor, said ink feed pump drive motor being independent from said drive motors for said forme cylinder, said at least one ink distribution cylinder and said plurality of ink metering pumps.
